(19) United States
(12) Patent Application Publication
(10) Pub. No.: US 2003/0047661 A1
(43) Pub. Date: Mar. 13, 2003

(54) Anti-vibration assembly and anti-vibration support forming part of this assembly

(76) Inventors: Gilles Chenais, Marboue (FR); Vincent Salembier, Brunelles (FR); Franck Coudiere, Cravant (FR); Patrick Garaud, St-Denis Les Ponts (FR)

Correspondence Address: MCCRACKEN AND FRANK, 200 W. ADAMS STREET, SUITE 2150, CHICAGO, IL, 60606, US

(21) Appl. No.: 10/230,871

(22) Filed: Aug. 29, 2002

(30) Foreign Application Priority Data
Sep. 5, 2001 (FR) 01 11475

(51) Int. Cl. F16M 1/00

(52) U.S. Cl. 248/638

(57) ABSTRACT

Anti-vibration assembly comprising an engine and a beam and an anti-vibration support for connecting the engine and the beam, damping vibration between the engine and the beam and supporting the weight of the engine in the vertical direction. The anti-vibration support comprises an inner armature and an outer armature which are connected respectively to the engine and to the beam. An elastomer body provides the connection between the inner armature and the outer armature. The outer armature forms a casing in which the inner armature (5) is force-fitted.

The inner armature may come into direct abutment against the beam via the elastomer body.

### BACKGROUND OF THE INVENTION

The invention relates to anti-vibration assemblies and to the method of mounting them.

More specifically, the invention relates to an anti-vibration assembly comprising first and second rigid elements and an anti-vibration support for connecting these two elements, damping vibration between these two elements and supporting a load in a vertical first direction, the support itself comprising:

two rigid armatures, an inner and an outer one respectively, which are designed to be connected respectively to the first and second rigid elements, the outer armature forming a casing of annular shape surrounding the inner armature (in this text, the term “annular” corresponds not only to a circular shape but also to any shape which is closed on itself in the manner of a ring) and having a passage through which the inner armature passes, and

an elastomer body providing a connection between the inner armature and the outer armature.

Anti-vibration assemblies of this type comprising an anti-vibration support are known, particularly the one described in document FR 2 789 464. In such assemblies, the first and second rigid elements consist respectively of the engine and of the body of a vehicle, the inner and outer armatures are roughly concentric, with the elastomer body between the two; the outer armature is supported vertically, possibly via a bracket for interconnection, to the body; and the engine is fixed to the inner armature by a vertical axial screw located roughly at the centre of the elastomer body. The engine is therefore supported elastically on the outer armature at a anchoring point relatively distant from the body.

Such assemblies are entirely satisfactory but it is sometimes the case that there is a desire to increase their ability to damp out vibration still further.

### SUMMARY OF THE INVENTION

One object of the present invention is to provide an anti-vibration assembly that allows this desire to be met.

To this end, the invention proposes an anti-vibration assembly of the type indicated hereinabove in which the inner armature runs longitudinally, in a horizontal second direction, between a first end situated outside the casing and a second end situated inside the casing and able to come into abutment against the second rigid element to limit, in a first way, the horizontal movement of the inner armature with respect to the outer armature, and in which the elastomer body collaborates with the outer armature in a region roughly flush with a face opposite the passage.

By virtue of this arrangement, the inner armature is roughly horizontal and in part rests on the outer armature in a region near to its point(s) of attachment to the body. The anchoring point is therefore situated near the body. This thus reduces as far as possible the torque effect between the point of anchorage of the engine and the body. The amplitude of the vibration, for the same force exerted by the engine on the body, is therefore decreased.

In some preferred embodiments of the invention, recourse is had to one and/or other of the following arrangements:

the casing comprises a lower wall and an upper wall which are roughly perpendicular to the first direction, and two side walls running between the lower wall and the upper wall roughly perpendicular to a third direction which is itself roughly perpendicular to the first and second directions, each of the side walls having a rib running in the second direction;

the inner armature has two lateral stop rims, each lateral stop rim running, in the casing, along a longitudinal edge of the inner armature in a plane roughly parallel to the side walls, each lateral stop rim comprising an external face, at least partly covered by the elastomer body, and each lateral stop rim limiting the movement of the inner armature in the casing in one of the two opposite ways of the third direction;

the passage is surrounded by a partition running in a plane roughly perpendicular to the second direction and the inner armature comprises a shoulder running from at least one of the two lateral stop rims near the passage in a plane perpendicular to the second direction, this shoulder being able to collaborate with the partition to limit the movement of the inner armature in the casing in the second direction in a second way which is the opposite of the first way, while retaining the inner armature in the casing;

the inner armature comprises, in the casing, a boss which has a convexness facing towards the lower wall, this boss being at least partly covered by the elastomer body limiting and damping the movements, downwards, of the inner armature in the casing;

the inner armature comprises, in the casing, a cup, intended to collaborate with the outer armature, the elastomer body being bonded to this cup and this cup having edges wedged between the lower wall and the ribs;

the inner armature comprises, in the casing, an end stop rim running, at the second end of the inner armature, in a plane roughly parallel to the first direction and roughly perpendicular to the second direction, this end stop rim being at least partly covered by the elastomer body;

the anti-vibration assembly consists of a structure of a motor vehicle and an engine, in which assembly the first rigid element consists of the engine and the second rigid element is a beam of the structure of the motor vehicle; and

the casing is closed, on the opposite side to the passage, by the beam to which the casing is fixed.

In another aspect, the invention is an anti-vibration support for connecting the two rigid elements of an anti-vibration assembly as mentioned hereinabove and damping the vibration between these two elements.

In yet another aspect, the invention is a motor vehicle comprising an anti-vibration assembly as mentioned hereinabove.

In yet another aspect, the invention is a method of mounting an anti-vibration assembly as mentioned hereinabove, in which the internal armature is slipped into the casing by offering up the first end of the inner armature, and the casing is closed on the opposite side to the passage by securing the outer armature to the second rigid element, enclosing and retaining part of the inner armature, this part being the one to which the elastomer body is bonded.

### BRIEF DESCRIPTION OF THE DRAWINGS

Other aspects, objects and advantages of the invention will become apparent from reading the detailed description which follows of one of its embodiments. The invention will also be better understood with the aid of the references to the drawings, in which:

FIG. 1 depicts schematically, in perspective, an anti-vibration support for connecting two rigid elements of an anti-vibration assembly in accordance with the present invention;

FIG. 2 depicts schematically, in perspective, the inner armature of the anti-vibration support depicted in FIG. 1;

FIG. 3 depicts schematically, in perspective with partial cutaway, viewed from above, an anti-vibration assembly comprising the anti-vibration support depicted in FIG. 1;

FIG. 4 is a schematic section, on a vertical plane, of the anti-vibration support depicted in FIG. 1;

FIG. 5 is another schematic section, on another vertical plane, of the anti-vibration support depicted in FIG. 1; and

FIG. 6 is yet another schematic section, on yet another vertical plane, of the anti-vibration support depicted in FIG. 1.

### DESCRIPTION OF A PREFERRED EMBODIMENT

The anti-vibration assembly according to the present invention comprises a first and a second rigid element, and an anti-vibration support for connecting these two elements.

In the embodiment of the invention which is described hereinbelow by way of nonlimiting example in relation to the figures, the anti-vibration assembly 1 comprises a structure of a motor vehicle and an engine 2, in which assembly the first rigid element consists of the engine 2 and the second rigid element consists of a beam 3 of the structure of the motor vehicle.

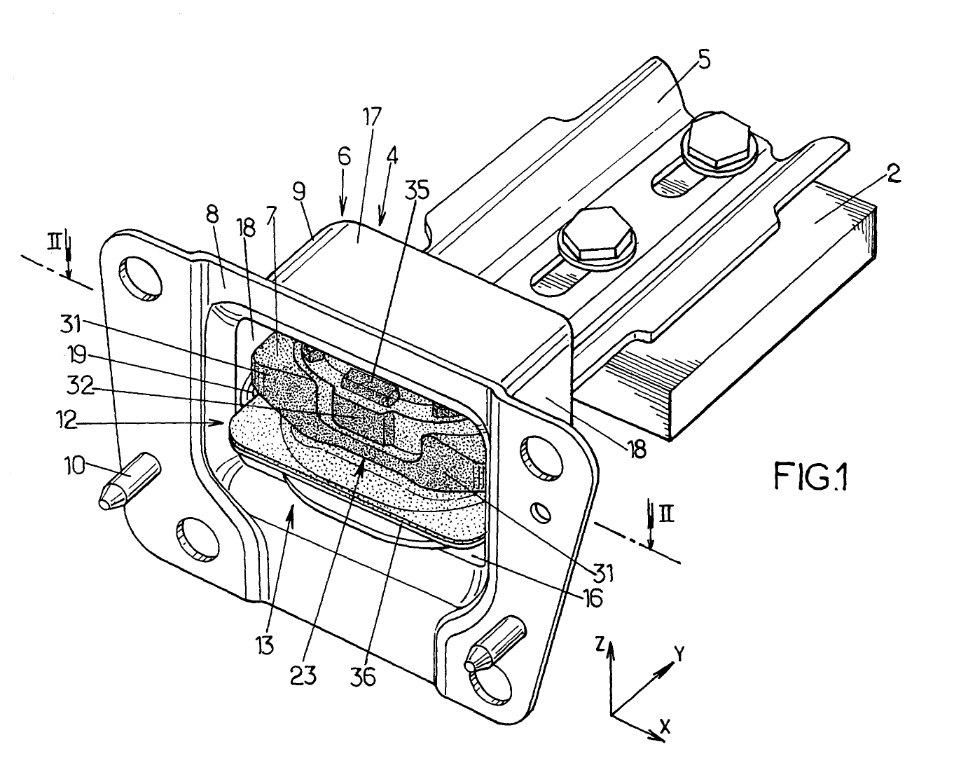

Referring to FIG. 1, the anti-vibration support 4 comprises an inner armature 5 and an outer armature 6, both of which are rigid and made of metal, and an elastomer body 7. The anti-vibration support supports the engine 2 in a vertical direction Z.

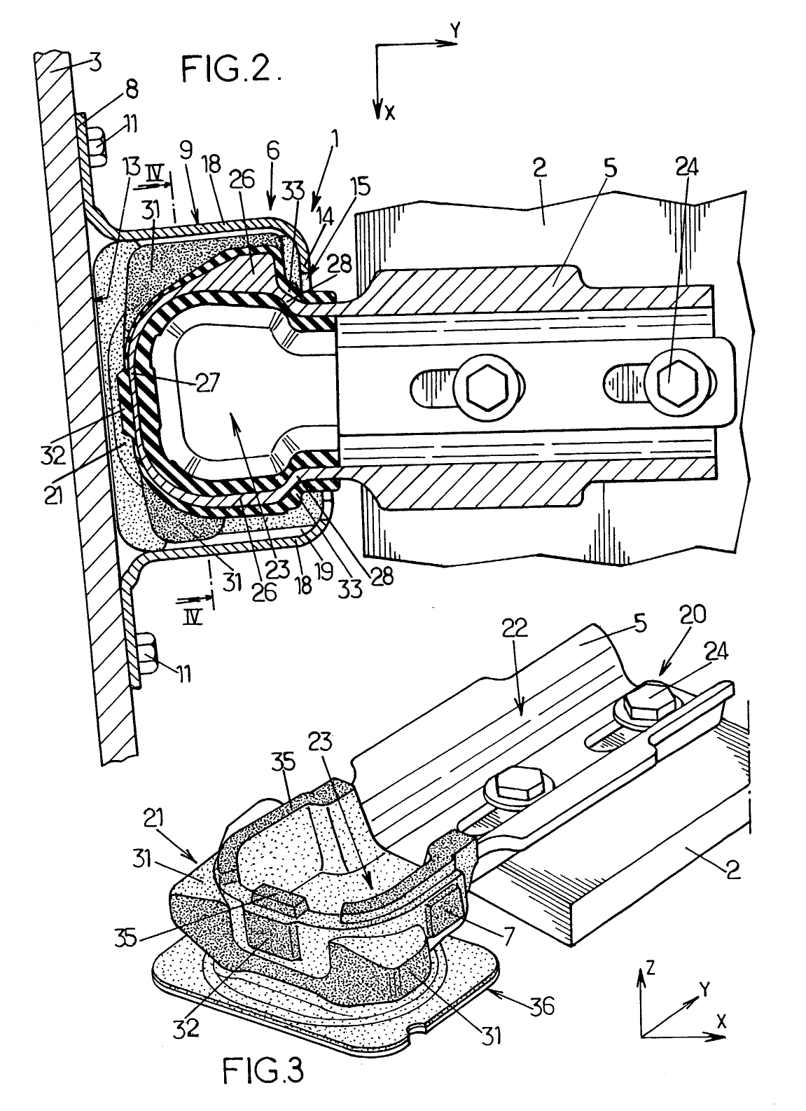

As depicted in FIGS. 1 and 2, the outer armature 6 comprises a fixing plate 8 and a casing 9.

The fixing plate 8 runs in a vertical plane parallel to the vertical direction Z and to a horizontal direction X. It is intended to be fitted on the beam 3 by means of pegs 10 and fixed thereto, in a conventional way, by means of bolts 11. The fixing plate 8 has a roughly rectangular opening 12. The casing 9 has a parallelepipedal annular shape. It has an open face 13 corresponding to the opening 12, and a partition 14, parallel to the open face 13, opposite the latter and having a passage 15 intended to be passed through by the inner armature 5. It also has a lower wall 16 and an upper wall 17 which are roughly perpendicular to the direction Z, and two side walls 18, running between the lower wall 16 and the upper wall 17 roughly perpendicular to the direction X (see also FIG. 4). A rib 19, projecting towards the inside of the casing 9, runs along roughly the lower ⅖ of each of the side walls 18 and roughly longitudinally in a direction Y perpendicular to the directions X and Z.

As depicted in FIGS. 1, 2 and 3, the inner armature 5 runs longitudinally, in the direction Y, between a first end 20 and a second end 21. The inner armature 5 comprises a first part 22 in the form of a groove, towards the first end 20, and a second part 23 which is hollow and covered by the elastomer body 7, towards the second end 21.

The first part 22 is fixed, in a conventional way, to the engine 2, by bolts 24.

The second part 23 has a bottom 25, two lateral stop rims 26, an end stop rim 27, two shoulders 28 and a boss 29 (see also FIGS. 4 to 6).

Each lateral stop rim 26 runs, from the bottom 25 towards the upper edge 30 of the second part 23, in a plane roughly parallel to the side walls 18. The end stop rim 27 runs, from the bottom 25 towards the upper edge 30 of the second part 23, between the two lateral stop rims 26, at the second end 21 of the inner armature 23, in a plane roughly perpendicular to the direction Y. Each shoulder 28 extends a lateral stop rim 26 towards the inside of the casing 9 in a plane perpendicular to the direction Y at the meeting point between the first part 22 and the second part 23 of the inner armature 6. Each shoulder 28 runs from the bottom 25 towards the upper edge 30 of the second part 23. The boss 29 is formed in the bottom 25 of the second part 23. It has a convexness facing towards the lower wall 16.

The elastomer body 7 entirely covers the second part 23 to which it is bonded. It has lateral protrusions 31, an end protrusion 32, shoulder protrusions 33, a lower protrusion 34 and an upper protrusion 35 corresponding to additional thicknesses of the elastomer material respectively at each lateral stop rim 26, at the end stop rim 27, at each shoulder 28, at the boss 29 and at the upper edge 30 of the second part 23. These protrusions 31, 32, 33, 34, 35 run from the end stop rim 27, from each lateral stop rim 26, from each shoulder 28 and from the boss 29 towards the beam 3, or the walls 16, 17, 18 or the partition 14 of the casing 9. These protrusions 31, 32, 33, 34, 35 damp the relative movements between, respectively, each lateral stop rim 26 and the side wall 18 opposite, the end stop rim 27 and the beam 3, each shoulder 28 and the partition 14, the boss 29 and the lower wall 16, and between the upper edge 30 of the second part 23 and the upper wall 17.

The inner armature 5 further comprises a cup 36 intended to collaborate with the outer armature 6. This cup 36 covers the underneath of the elastomer body 7. This cup 36 has a bottom 37, flanks 38 and an edge 39.

The bottom 39 runs roughly parallel to the lower wall 16. It is open facing the protrusion covering the boss 29. The flanks 38 run in a continuation from the bottom 37, parallel respectively to the side walls 26, to the beam 3 and to the partition 14. The edge 39 extends the flanks 38 parallel to the lower wall 16.

The height of the flanks 38 is such that the upper level of the edge 39 is wedged, at the side walls 16, under the ribs 19, while the bottom 37 rests against the lower wall 16.

The inner armature 5 and the outer armature 6 are assembled by first of all introducing the first part 22 into the casing 9. The cup 36 is then force-fitted into the casing 9. The casing 9 is closed by fixing the fixing plate 8 to the beam 3. The beam 3 therefore closes off the open face 13. This arrangement avoids screw-fastening the inner armature 5 and the outer armature 6 together.

By virtue of the arrangements mentioned hereinabove, and as illustrated in FIGS. 4, 5 and 6, it is possible to limit the relative movement of the inner armature and of the outer armature in the two ways of each of the three directions X, Y and Z.

FIG. 4 shows that the movements of the inner armature 5 with respect to the outer armature 6 in the two ways of the direction Z are damped by the upper 35 and lower 34 protrusions, whereas the movements in the direction X of the inner armature 5 towards the side walls 18 are damped by the lateral protrusions 31. The architecture of the lateral stops (lateral protrusions 31 with respect to the side walls 18) allows better progressiveness in the limitations and better filtration of vibration under torque in the plane X-Y.

FIG. 5 shows that the movements of the inner armature 5 with respect to the outer armature 6 in the two ways of the direction Z are damped by the upper 38 and lower 34 protrusions, while the movement of the inner armature 5 towards the beam 3 is damped, in a first way of the direction Y, by the end protrusion 32. This figure also illustrates the fact that the elastomer body 7 collaborates with the outer armature 6 via the cup 36, in a region roughly flush with the open face 13, therefore near the beam 3. Thus, the elastic centre of the anti-vibration support 4 is close to the beam 3. This architecture makes it possible to limit the moments between the engine 2 and the beam 3 and to reduce the amplitude of the vibration with respect to that which is observed, for the same force, in anti-vibration assemblies of the prior art.

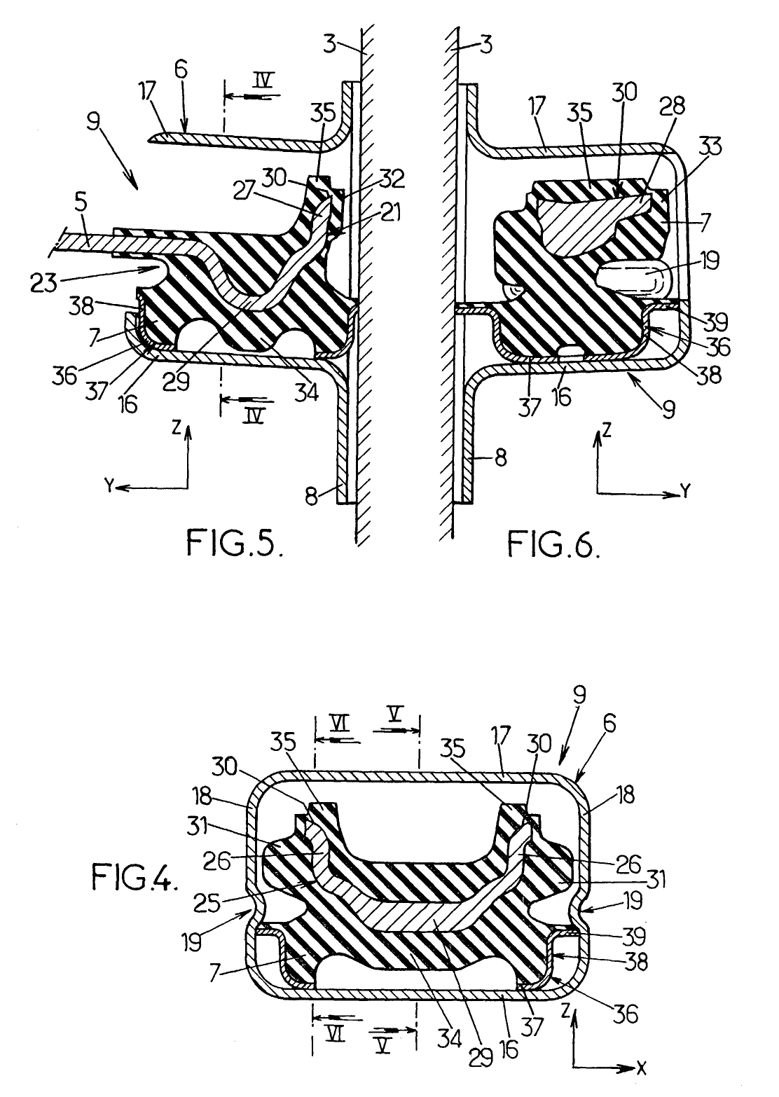

FIG. 6 shows that the movements of the inner armature 5 with respect to the outer armature 6 in the second way of the direction Y are damped by the shoulder protrusions 33.

The invention is not in any way restricted to the embodiment set out hereinabove. It also encompasses numerous alternative forms. For example, the elastomer body may be supplemented by a hydraulic pad with two chambers filled with liquid and separated from one another by a restricted passage.

What is claimed is:

1. Anti-vibration assembly comprising first and second rigid elements and an anti-vibration support for connecting these two elements, damping vibration between these two elements and supporting a load in a vertical first direction, the support itself comprising:
two rigid armatures, an inner and an outer one respectively, which are designed to be connected respectively to the first and second rigid elements, the outer armature forming a casing of annular shape surrounding the inner armature and having a passage through which the inner armature passes, and
an elastomer body providing a connection between the inner armature and the outer armature, characterized in that:
the inner armature runs longitudinally, in a horizontal second direction, between a first end situated outside the casing and a second end situated inside the casing and able to come into abutment against the second rigid element to limit, in a first way, the horizontal movement of the inner armature with respect to the outer armature, and
the elastomer body collaborates with the outer armature in a region roughly flush with a face opposite the passage.

2. Anti-vibration assembly according to claim 1, in which the casing comprises a lower wall and an upper wall which are roughly perpendicular to the first direction, and two side walls running between the lower wall and the upper wall roughly perpendicular to a third direction which is itself roughly perpendicular to the first and second directions, each of the side walls having a rib running in the second direction.

3. Anti-vibration assembly according to claim 2, in which the inner armature has two lateral stop rims, each lateral stop rim running, in the casing, along a longitudinal edge of the inner armature in a plane roughly parallel to the side walls, each lateral stop rim comprising an external face, at least partly covered by the elastomer body, and each lateral stop rim limiting the movement of the inner armature in the casing in one of the two opposite ways of the third direction.

4. Anti-vibration assembly according to claim 3, in which the passage is surrounded by a partition running in a plane roughly perpendicular to the second direction and the inner armature comprises a shoulder running from at least one of the two lateral stop rims near the passage in a plane perpendicular to the second direction, this shoulder being able to collaborate with the partition to limit the movement of the inner armature in the casing in the second direction in a second way which is the opposite of the first way, while retaining the inner armature in the casing.

5. Anti-vibration assembly according to claim 2, in which the inner armature comprises, in the casing, a boss which has a convexness facing towards the lower wall, this boss being at least partly covered by the elastomer body limiting and damping the movements, downwards, of the inner armature in the casing.

6. Anti-vibration assembly according to claim 2, in which the inner armature comprises, in the casing, a cup, intended to collaborate with the outer armature, the elastomer body being bonded to this cup and this cup having edges wedged between the lower wall and the ribs.

7. Anti-vibration assembly according to claim 1, in which the inner armature comprises, in the casing, an end stop rim running, at the second end of the inner armature, in a plane roughly parallel to the first direction and roughly perpendicular to the second direction, this end stop rim being at least partly covered by the elastomer body.

8. Anti-vibration assembly according to claim 1, comprising a structure of a motor vehicle and an engine, in which assembly the first rigid element consists of the engine and the second rigid element is a beam of the structure of the motor vehicle.

9. Anti-vibration assembly according to claim 8, in which the casing is closed, on the opposite side to the passage, by the beam to which the casing is fixed.

10. Anti-vibration support for connecting the two rigid elements of an anti-vibration assembly according to claim 1 and damping the vibration between these two elements.

11. Motor vehicle comprising an anti-vibration assembly according to claim 1.

12. Method of mounting an anti-vibration assembly according to claim 1, in which the internal armature is slipped into the casing by first of all offering up into the casing the first end of the inner armature, and the casing is closed on the opposite side to the passage by securing the outer armature to the second rigid element, enclosing and retaining part of the inner armature, this part being the one to which the elastomer body is bonded.
